(19) United States
(12) Patent Application Publication
(10) Pub. No.: US 2006/0120548 A1
(43) Pub. Date: Jun. 8, 2006

(54) Speaker device

(75) Inventor: Dong-uk Jang, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/159,224

(22) Filed: Jun. 23, 2005

(30) Foreign Application Priority Data
Dec. 2, 2004 (KR) 10-2004-0100435

(51) Int. Cl. H04R 1/02; H04R 9/06

(52) U.S. Cl. 381/338; 381/349; 381/335; 181/182

(57) ABSTRACT

The present invention relates to a speaker device having a speaker casing that is substantially shaped like a tube, and a speaker unit accommodated in a first end part of the speaker casing such that a front emission part of the speaker unit faces toward an outside direction of the first end part of the speaker casing and having a predetermined resonance distance from a back end part of the speaker unit to an open second end part of the speaker casing. Accordingly, the present invention can be used to provide a speaker device which is reinforced in a low sound range.

### CROSS-REFERENCE TO RELATED APPLICATIONS

This application claims the benefit under 35 U.S.C. 119(a) of Korean Patent Application No. 10-2004-0100435, filed in the Korean Intellectual Property Office on Dec. 2, 2004, the entire disclosure of which is incorporated herein by reference.

### BACKGROUND OF THE INVENTION

1. Field of the Invention

The present invention relates to a speaker device. More particularly, the present invention relates to a speaker device that is reinforced in a low sound range.

2. Description of the Related Art

Generally, a conventional low sound range reinforcing speaker device is classified as a base reflex type or a transmission airline type.

As shown in FIG. 1, a base reflex type speaker device 101 comprises a cabinet 110. A duct 130 is provided in a front portion of the cabinet 110 or in a back portion of the cabinet 110. A speaker unit 120 is also provided, and a backside sound emitted from the speaker unit 120 makes a predetermined frequency resonate by air reaction and air mass inside the cabinet 110.

As shown in FIG. 2, a transmission airline type speaker device 201 is transformed from the base reflex type speaker device 101. In the transmission airline type speaker device 201, a low sound range speaker 220a is equipped on an upper part of a casing 210. Also, a middle sound range speaker 220b and a high sound range speaker 220c are equipped on a lower part of the casing 210. Between the low sound range speaker 220a, and the middle sound range speaker 220b and high sound range speaker 220c, a partition part 230 is provided to separate an equipment area. On a lower part of the partition part 230, a blocking plate 240 is provided to isolate the equipment area and a sound passage. Also, on a lower part of the partition part 230, several sound passage plates 250 are mounted to form a sound passage.

As shown in FIGS. 1 and 2, the conventional speaker device creates phase reversing by controlling a transmission time of a sound wave delivered to a back of a vibration plate of the speaker unit, or by controlling a path of the sound wave. Also, the conventional speaker device is designed to reinforce the low sound range by inducing rise interference between a sound wave transmitted in front of the vibration plate and a sound wave of the low sound range.

However, such a conventional speaker device is required to have enough internal capacity to be equipped with several sound passage tubes in the speaker device to reinforce the low sound range. Accordingly, the conventional speaker device needs a wider location for placement because a size of the speaker device becomes bigger. Also, the conventional speaker device reinforces the low sound range, but it does not relatively exclude the sound wave of the high sound range. Therefore, in the conventional speaker device, it is difficult to expect an amplifying effect, while reinforcing only the low sound range that is under the predetermined frequency and filtering the high sound range that is over the predetermined frequency.

Accordingly, a need exists for a speaker device system and method for providing an improved sound quality by reinforcing the low sound range, while also decreasing the required speaker device space.

### SUMMARY OF THE INVENTION

Accordingly, it is an aspect of the present invention to provide a speaker device which is reinforced in a low sound range.

Additional aspects and advantages of the present invention will be set forth in part in the description which follows and, in part, will be obvious from the description or may be learned by practice of the present invention.

The foregoing and other aspects of the present invention are substantially achieved by providing a speaker device comprising a speaker casing that is preferably shaped like a tube, and a speaker unit that is accommodated in a first end part of the speaker casing, such that a front emission part of the speaker unit faces toward the outside of the first end part of the speaker casing, and having a predetermined resonance distance from a back end part of the speaker unit to a second end part of the speaker casing.

According to an aspect of the present invention, a speaker device according to an embodiment of the present invention comprises a predetermined resonance distance of more than 400 mm.

According to another aspect of the present invention, a speaker device according to an embodiment of the present invention further comprises a sound emission member, which is equipped with the first end part of the speaker casing and which emits the sound occurring from the front emission part in a predetermined direction.

According to another aspect of the present invention, a speaker device according to an embodiment of the present invention comprises a sound emission member that emits the sound occurring from the speaker unit over a 360 degree area.

According to another aspect of the present invention, a speaker device according to an embodiment of the present invention further comprises a sound emission member, which is equipped with the first end part of the speaker casing and emits a sound generated from the front emission part in a predetermined direction.

According to another aspect of the present invention, a speaker device according to an embodiment of the present invention comprises the sound emission member that is made to emit the sound occurring from the speaker unit over a 360 degree area.

### BRIEF DESCRIPTION OF THE DRAWINGS

The above and other aspects and advantages of the present invention will become apparent and more readily appreciated from the following description of the exemplary embodiments, taken in conjunction with the accompanying drawings of which:

FIG. 1 is a side cross-sectional view illustrating a conventional base reflect type speaker device;

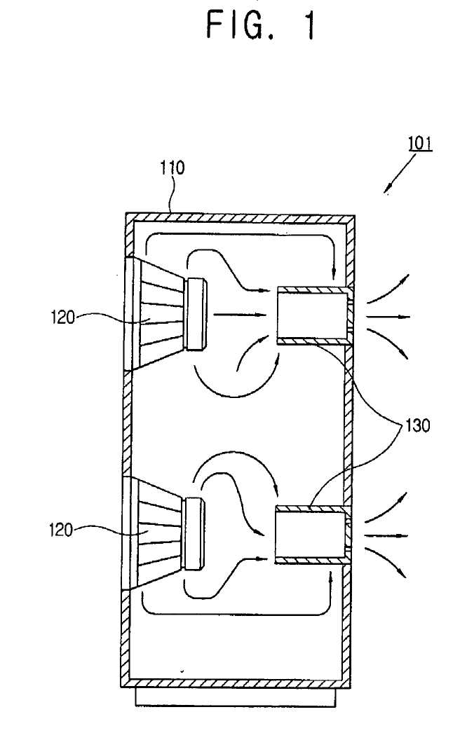

FIG. 2 is a side cross-sectional view illustrating a conventional transmission airline type speaker device;

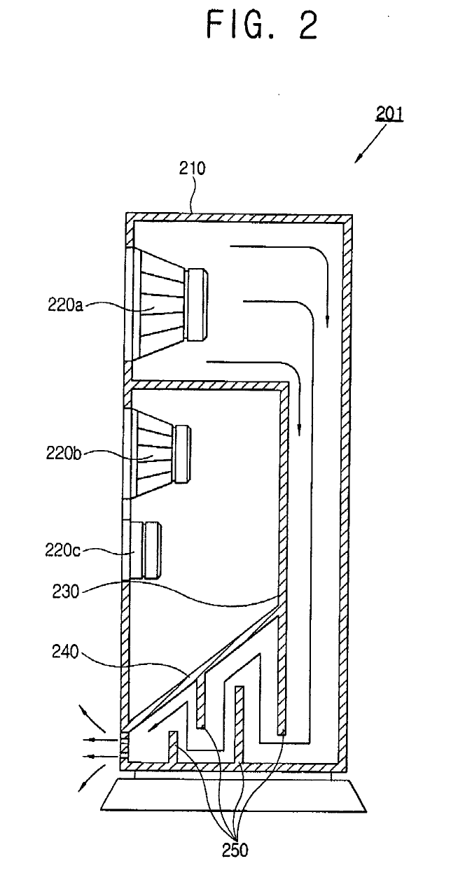

FIG. 3 is a front view illustrating a speaker device in accordance with an embodiment of the present invention; and

FIG. 4 is a partial cross-sectional view illustrating the speaker device of FIG. 3 in greater detail.

Throughout the drawings, like reference numerals will be understood to refer to like parts, components and structures.

### DETAILED DESCRIPTION OF EXEMPLARY EMBODIMENTS

Reference will now be made in detail to embodiments of the present invention, examples of which are illustrated in the accompanying drawings, wherein like reference numerals refer to like elements throughout.

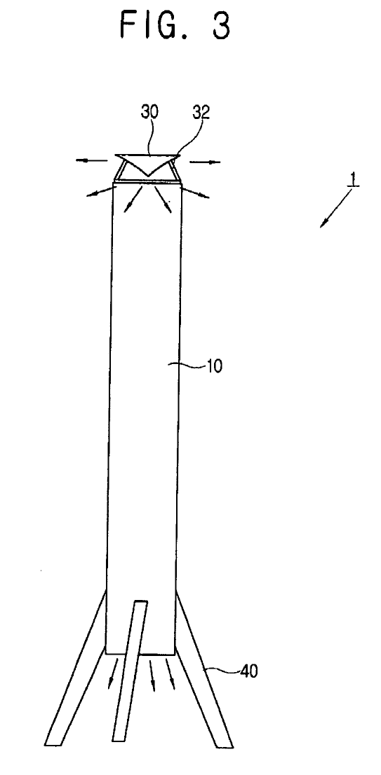

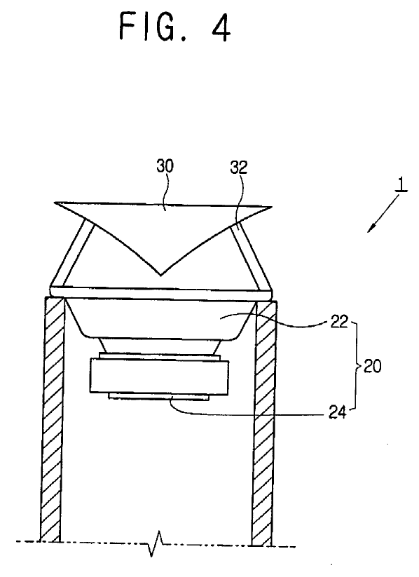

As shown in FIGS. 3 and 4, a speaker device 1 according to an embodiment of the present invention comprises a speaker casing 10 that is preferably shaped like a cylinder or tube, a speaker supporter 40 for supporting the speaker casing 10, a speaker unit 20 inserted in the speaker casing 10 to make a sound, and a sound emission member 30 to emit the sound generated from the speaker unit 20.

An exemplary embodiment of the speaker casing 10 is shaped like a long pipe. On a first end of the speaker casing 10, the speaker unit 20 is disposed for making sound. A second end of the speaker casing 10 is open. The speaker casing 10, therefore, is substantially shaped like a partially closed cylinder that is closed at the first end part and open at the second end part. The speaker casing 10 has a predetermined resonance distance from a back end part 24 of the speaker unit 20, to the second end part of the speaker casing 10. The resonance distance may be more than 400 mm to reinforce a low sound range (that is, a range approximately under 200 Hz). The sound of all ranges, from low sounds to high sounds, that are generated from the speaker unit 20 are emitted to the first end part of the speaker casing 10. The sound of the low sound range that is reinforced by a resonance, is emitted to the second end part of the speaker casing 10.

In the speaker unit 20, a vibration plate (not shown) is provided and makes sound by a vibration. The sound generated from the speaker unit 20 is emitted to and out of the first end part of the speaker casing 10 through a front emission part 22 of the speaker unit 20. The sound generated from the speaker unit 20 is also emitted to and out of the second end part of the speaker casing 10 through a back end part 24 of the speaker unit 20. At this time, the backside sound is reinforced in the low sound range and set off from the high sound range as described in greater detail below. The sound emitted to and out of the first end part of the speaker casing 10 by the speaker unit 20 can be emitted over a 360 degree area by the sound emission member 30.

As shown in FIG. 4, the sound emission member 30 is substantially shaped like a cone in a reversed direction as viewed from a side view. According to a rule of reflection, a reflected sound has a reflected angle that is the same as an incident angle of an incident sound in a specular reflection. Accordingly, the sound emission member 30 is substantially shaped like a cone in a reversed direction to emit the sound generated from the speaker unit 20 over a 360 degree area as shown by the arrows of FIG. 3. The sound emission member 30 is supported at the first end of the speaker casing 10 by a supporting part 32, thereby realizing a speaker device of non-directivity.

With an exemplary embodiment of a speaker devise constructed according to the above configuration, a principle reinforcing of the low sound range is provided as described in greater detail below.

The first end part of the speaker casing 10 accommodates the speaker unit 20, and the second end part of the speaker casing 10 is open. Therefore, the speaker casing 10 is formed substantially in the shape of a partially closed pipe. In such a partially closed pipe, a stationary wave occurs when a length of the speaker casing 10 satisfies a condition defined by the following Equation (1).
length of the pipe=wavelength of frequency reproducing×¼, ¾, 5/4, 7/4 (1)

This stationary wave makes the resonance, that is, the resonance in the compulsory vibration by the speaker unit 20 and which is defined as an increasing phenomenon of an amplitude when the number of vibrations of the outside equals the number of vibrations in the system.

The sound formed by the speaker unit 20 does not occur from a point sound source, but from a surface sound source. Therefore, the sound formed by the speaker unit 20 follows various courses in the speaker casing 10. Accordingly, although at the same frequency, the sound has respectively a different phase in an opening area of the speaker casing 10. In the case of the frequency of the middle sound range or the high sound range, the wavelength is short and the phase displacement is large. This phase displacement occurs due to the difference in the course traveled. When the phase displacement occurs, a sound pressure, or volume, of a high frequency is lowered. However, in the case of the frequency of the low sound range, the phase displacement is small because of the long wavelength. The longer the wavelength, the more resonance is generated because the phase displacement of the wave length is small. Therefore, the frequency of the low sound range is reinforced by the resonance.

Also, a sound absorbing material is inserted in the speaker casing 10 to reduce noise. By providing the sound absorbing material, the sound pressure, or volume, of the middle sound range and the high sound range is largely reduced. However, the sound pressure, or volume, of the low sound range under 200 Hz is not decreased by the sound absorbing materials. Accordingly, the low sound range is reinforced more than the middle sound range and the high sound range. Therefore, only the low frequency sound is reinforced by the resonance and emitted through the second end part of the speaker casing 10. However, all kinds of sounds such as the low range sound, middle range sound, and high range sound are emitted to the outside of the speaker casing 10 by the front emission part 22 because there is no influence by the resonance with respect to the front emission part 22 of the speaker unit 20.

In the exemplary embodiments of the present invention, the resonance distance of the speaker casing 10 may be designed to be more than 400 mm based on Equation (1) and the following Equation (2),
(resonance frequency f=sound speed/(4×length of the pipe) (2)
wherein the sound speed is 340 m/s.

As described above, an exemplary embodiment of the speaker device of the present invention has a speaker casing 10 that is substantially shaped like a narrow and long cylinder body, and the speaker unit 20 is equipped in the speaker casing 10. Also, in such an exemplary speaker device, only the low sound range is reinforced by the resonance of the backside emission sound of the speaker unit 20. Accordingly, in such an exemplary speaker device, the quality of the sound is improved by reinforcing the low sound range by the resonance. Also, it is possible to equip such an exemplary speaker device in a narrow location, thereby sharply decreasing the space required for the speaker device.

A conventional speaker device emits sound toward a front of the device, but a speaker device according to an embodiment of the present invention can emit sound over a 360 degree area by using the sound emission member 30, thereby realizing a speaker device of non-directivity.

As described above, the resonance distance of the speaker casing 10 may be more than 400 mm, but in yet other embodiments of the present invention, the distance can be changed to correspond to the low sound range frequency to be emphasized.

In the foregoing exemplary embodiments, the sound emission member 30 is substantially shaped like a cone in a reversed direction. Alternatively, in yet other embodiments of the present invention, the sound emission member 30 can be changed to other shapes or sizes as required to emit the sound over a 360 degree area. Also, the sound emission member 30 may be designed to provide directivity with a specific direction or directions.

Although only a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A speaker device comprising:
a speaker casing shaped substantially like a tube and comprising a first and second end part; and
a speaker unit comprising a front emission part and a back part, wherein the speaker unit is disposed in the first end part of the speaker casing such that the front emission part of the speaker unit faces toward an outside of the first end part of the speaker casing and having a predetermined resonance distance from the back end part of the speaker unit to the second end part of the speaker casing.

2. The speaker device according to claim 1, wherein the predetermined resonance distance is calculated to reinforce a low sound range that is emitted to the second end part of the speaker casing.

3. The speaker device according to claim 1, wherein the predetermined resonance distance is greater than 400 mm.

4. The speaker device according to claim 3, further comprising:
a sound emission member, which is equipped with the first end part of the speaker casing for emitting sound occurring from the front emission part of the speaker unit toward a predetermined direction.

5. The speaker device according to claim 4, wherein the sound emission member is substantially shaped like a cone.

6. The speaker device according to claim 4, wherein the sound emission member emits sound occurring from the speaker unit over a 360 degree area.

7. The speaker device according to claim 1, further comprising:
a sound emission member, which is equipped with the first end part of the speaker casing for emitting sound generated from the front emission part of the speaker unit toward a predetermined direction.

8. The speaker device according to claim 7, wherein the sound emission member is substantially shaped like a cone.

9. The speaker device according to claim 7, wherein the sound emission member is configured to emit sound occurring from the speaker unit over a 360 degree area.

10. The speaker device according to claim 1, further comprising a speaker supporter for supporting the speaker casing.

11. The speaker device according to claim 2, wherein the reinforced low sound range comprises a range of sounds under 200 Hz.

12. A method for providing an improved sound quality by reinforcing a low sound range in a speaker device, comprising the steps of:
providing a speaker casing shaped substantially like a tube and comprising a first and second end part;
providing a speaker unit comprising a front emission part and a back part in the speaker casing;
emitting sound from the front emission part of the speaker unit toward the first end part of the speaker casing, and emitting sound from the back part of the speaker unit to the second end part of the speaker casing, wherein the second end part of the speaker casing is at a predetermined resonance distance from the back end part of the speaker unit to reinforce a low sound range; and
emitting sound occurring from the first end part of the speaker casing over a 360 degree area.
